(19) United States
(12) Patent Application Publication
(10) Pub. No.: US 2004/0203592 A1
(43) Pub. Date: Oct. 14, 2004

(54) Introduction device, smart appliance and method of creating a federation thereof

(75) Inventors: Roger G. Kermode, Coogee (AT); Aidan Williams, Chifley (AT); James A. Lawrence, Coogee (AT)

Correspondence Address: MOTOROLA, INC., 1303 EAST ALGONQUIN ROAD, IL01/3RD, SCHAUMBURG, IL, 60196

(73) Assignee: MOTOROLA, INC.

(21) Appl. No.: 09/843,568

(22) Filed: Apr. 26, 2001

Related U.S. Application Data
(60) Provisional application No. 60/249,663, filed on Nov. 15, 2000.

(51) Int. Cl. H04B 5/00

(52) U.S. Cl. 455/411; 455/41.1; 455/575.1; 455/435.1

(57) ABSTRACT

A method of adding an appliance to a federation of appliances includes the steps of placing an introduction device in close proximity to the appliance and then establishing a secure communications channel between the appliance and the introduction device. Next, security information of the federation is transferred from the introduction device to the appliance. The appliance is thereafter a member of the federation.

### FIELD OF THE INVENTION

The present invention relates to systems that remotely communicate via an unsecure network with household appliances and consumer electronic devices, and more particularly to adding an appliance or electronic device to a federation or group of appliances and devices that share security information.

### BACKGROUND OF THE INVENTION

Today's homes include a large number of various kinds of appliances and electronic devices, such as refrigerators, air conditioners, heaters, washers, dryers, stereos and television sets. Such appliances and devices are presently being equipped with communications ports and processors so that they can be accessed, programmed and controlled from a remote location via a network like the Internet.

For example, a person working late in an office, stuck in traffic or on a train or subway, may desire to record a television program and turn on some lights prior to returning home. As the Internet and Internet access have become wide spread and readily available, being able to perform such tasks is made relatively easy if the person is able to send instructions to the appliances via the Internet. In one scenario, the person could access the Internet using his mobile phone or a PDA, and then transmit the proper instructions to his home appliances.

To allow these household appliances and electronic devices to be connected to a wide area network like the Internet, gateways will be found in homes, cars, offices, and in public spaces such as airports, cafes, and theatres. For access to these appliances to be acceptable to the general public, the ability of these appliances to be accessed and to access other devices must be restricted in order to keep people's appliances from being accessed by unauthorized parties. For example, if access is not restricted, a thief could inventory the appliances within a home via the home's network prior to robbing the home.

There are several other situations where this is important. One instance is “drive by” joining of networks occurring as mobile, wireless devices come into radio range of other wireless devices. Another instance is wireless networks with overlapping coverage as could be present in an apartment block with a number of home radio networks, perhaps associated with broadband network gateways. A further instance is any shared network, wired or wireless, where you only want to exchange traffic with a subset of devices on the network. In these scenarios, the devices are using a shared network to communicate with each other. Since other devices might be sharing the network, the communications cannot be assumed to be private.

The secure configuration of wireless appliances in the presence of multiple wireless gateways that share the same spectrum is problematic since the appliances cannot determine which gateway to use without communicating outside of the wireless band. If an out of band mechanism is not present then an imposter gateway can impersonate the desired gateway, enabling it to intercept data to and from the appliance.

Cryptographic techniques can be effectively used to secure communications over the shared network, at the cost of managing cryptographic keys. Current solutions involve pre-configuring the appliances and devices using PINs or passwords to derive encryption keys or ignoring the security issues entirely. Pre-configuring security information into devices restricts the number of devices you can communicate with and is typically onerous on the consumer. Sharing PINs or passwords with all of the devices you want to communicate with is not desirable if you share the one key with every device, or it is unmanageable if each device has it's own key. Not implementing security is not acceptable for widely deployed consumer items.

It would be convenient if a group or groups of devices could share the same security information. Such groups are referred to as federations. There is a clear need for simple, secure techniques for sharing security information between networked consumer devices. Therefore, there must be mechanisms to simply and securely create federations of devices that share security information like cryptographic keys and access control information that is used to restrict communication to a subset of devices and to ensure the confidentiality of data transferred over a shared network.

### SUMMARY OF THE INVENTION

The present invention is directed to mechanisms by which wireless devices can be introduced into a group of devices in a secure fashion, and which prevents these devices from being configured to communicate with an unauthorized gateway or device.

Accordingly, the present invention provides a method of creating a federation of appliances, including the steps of placing an introduction device in close proximity to a first appliance, establishing a secure communications channel between the introduction device and the first appliance and transferring security information of the federation between the introduction device and the first appliance. The introduction device is then placed in close proximity to a second appliance and a secure communications channel between the introduction device and the second appliance is established. Next, the security information from the introduction device is transferred to the second appliance. The first and second appliances are thereafter members of the same federation.

The present invention also provides a method of adding an appliance to an existing federation of appliances. First, an introduction device is placed in close proximity to the appliance. A secure communications channel is established between the appliance and the introduction device, and security information of the federation is transferred from the introduction device to the appliance, making the appliance a member of the federation.

The present invention further provides an introduction device for assigning an appliance to a federation of appliances in a secure manner. The introduction device includes a communications port that permits secure transfer of information between an appliance and the introduction device when the communications port is placed in close proximity to an appliance communications port. A memory is connected to the communications port for storing security information. A switch is provided that signals that the introduction device is to start communicating with the appliance. A processor, connected to the communications port, the memory and the switch reads the security information from the memory and transmits the security information to the appliance via the communications port, in response to a change in state of the switch. When the appliance receives the security information, the appliance becomes a member of a federation of appliances that share the same security information.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there is shown in the drawings embodiments that are presently preferred. It should be understood, however, that the invention is not limited to the precise arrangements and instrumentalities shown. In the drawings:

FIG. 1 is a schematic view of a federation of devices in accordance with the present invention;

FIG. 2A is a flowchart illustrating the creation of a federation of appliances in accordance with an embodiment of the present invention;

FIGS. 2B-2D are a series of drawings showing the creation of the federation of FIG. 2A;

FIG. 3A is a flowchart illustrating a first example of the addition of an appliance to an existing federation of appliances in accordance with the present invention;

FIGS. 3B-3D are a series of drawings showing the addition of a PDA to a federation in accordance with the flowchart of FIG. 3A;

FIGS. 4A-4C are a series of drawings showing the addition of a mobile telephone to a federation in accordance with the present invention;

FIGS. 5A-5C are a series of drawings showing the introduction of a gateway as a new device to a federation in accordance with the present invention;

FIG. 6 is schematic block diagram of an introduction device in accordance with the present invention; and

FIG. 7 is an enlarged, partial perspective view of one embodiment of a communications port of the introduction device of FIG. 6 and a communications port of an appliance.

### DETAILED DESCRIPTION OF PREFERRED EMBODIMENTS

In the drawings, like numerals are used to indicate like elements throughout. In addition, the terms appliance and device are both used to refer generally to household appliances such as refrigerators, washers and dryers and electronic devices such as televisions and stereos, and are thus used interchangeably.

The present invention uses proximity based information exchange mechanisms to transfer a shared secret between multiple devices and gateways that then allows the devices to communicate with one another over either wired or wireless links in a secure manner. If the shared secret is not established then the devices or appliances cannot communicate with each other.

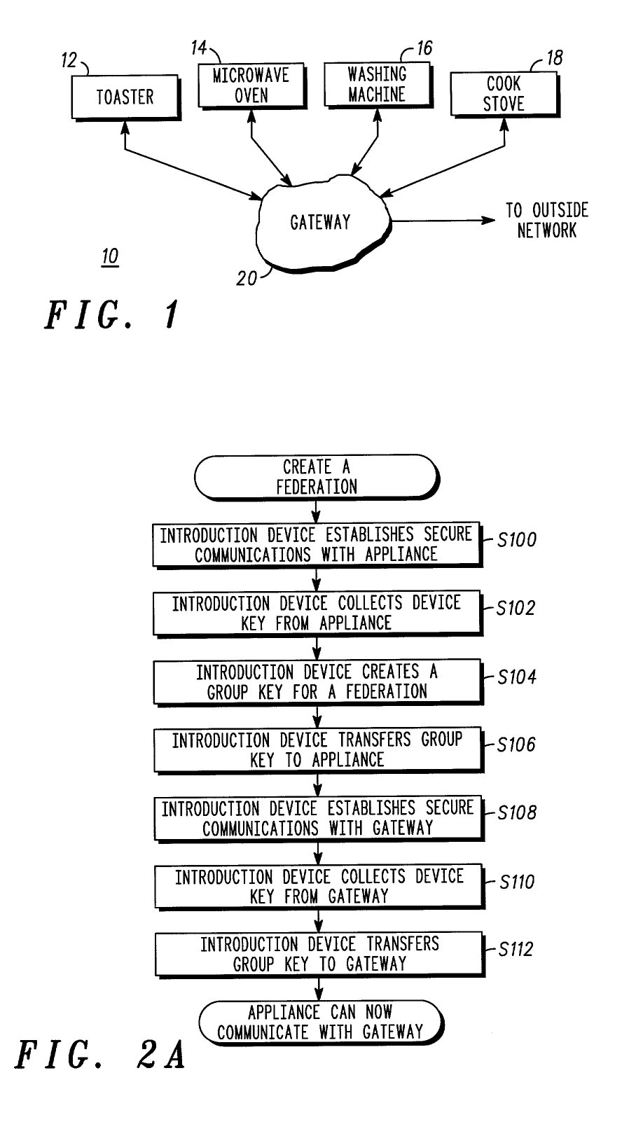

Referring to FIG. 1, an example of a federation of appliances 10 is shown. The federation of appliances 10 includes a toaster 12, a microwave oven 14, a washing machine 16 and a stove/oven 18, each of which is connected to a gateway 20 that allows the appliances to access or be accessed by other devices (not shown) via a network or device connected to the gateway 20. For example, a personal computer connected to a network such as the Internet could access the federation of appliances 10 via the gateway 20. Although a gateway is included in the federation shown in FIG. 1, it will be understood by those of ordinary skill in the art that a gateway is not required. That is, federations of devices can be formed without a gateway being present.

Each of the appliances 12-18 is a so-called smart appliance that includes a processor and communications system that allows it to receive commands such as on, off, and timer commands and to transmit status information such as on, off, process being performed, remaining on time, and malfunction information. Such smart appliances and their communications systems are presently available and are understood by those of skill in the art and a detailed discussion thereof is not required for those of skill in the art to understand the present invention.

In this example, the appliances 12-18 are each connected to the gateway 20. The appliances 12-18 can be connected to the gateway 20 via a communications line, a power line communications system or a wireless link. The gateway 20 provides a communications link to the federation of appliances 10. The gateway 20 can be a modem, such as a cable modem, a telephone modem, or other communications device that provides a communications link to the federation of appliances 10 that allows the appliances 12-18 to be accessed from a remote location.

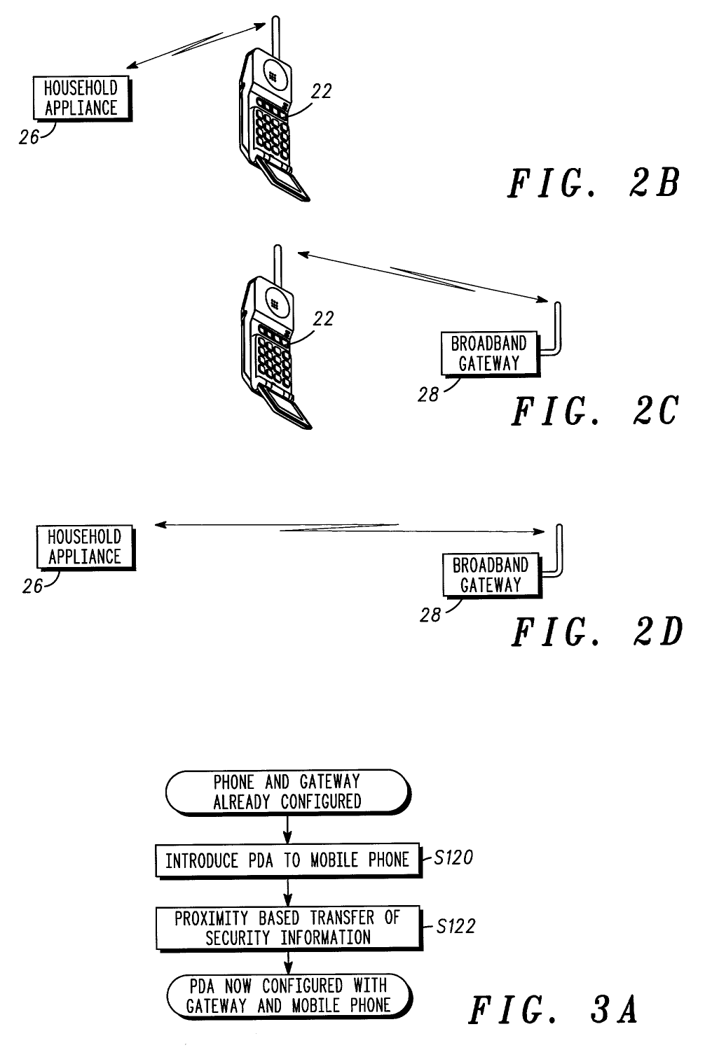

Referring now to FIGS. 2A-2D, the present invention provides a method of creating a federation of appliances such as the federation 10 shown in FIG. 1. FIG. 2A is a flowchart showing the steps for creating a federation of appliances and FIGS. 2B-2D are a series of drawings showing the creation of the federation in accordance with FIG. 2A.

A federation of appliances is created by establishing a secure communications channel between an introduction device 22 and a first household appliance 26, such as a refrigerator. The introduction device 22 may be a wand type device designed specifically to communicate with smart appliances or another type of electronic device that includes introduction capabilities, such as a mobile or cellular telephone, a personal digital assistant (PDA), and other portable computing devices. In FIG. 2B, the introduction device 22 is a cellular telephone.

In step S100, the introduction device 22 establishes a secure communications channel with the household appliance 26. A secure communications channel may be established through the use of cryptographic techniques like Diffie-Hellman key agreement. However, as discussed in more detail below, it is preferred that a secure channel is formed by placing the introduction device 22 in close proximity to the household appliance 26 and then using a short range wireless infrared protocol or by placing the introduction device 22 in direct contact with the household appliance 26. The close proximity or direct contact between the introduction device 22 and the appliance 26 increases key exchange security significantly since interception of the messages being exchanged is more difficult than when messages are transmitted via RF.

In step S102, the introduction device 22 collects a device key from the household appliance 26. Devices keys can be stored in a memory within the appliance 26 or attached to a storage medium on the appliance 26 such as an RFID (radio frequency identification) tag or a barcode. Alternatively, a device key could be generated by the introduction device 22 itself and transferred to the appliance 26. The device key is collected from the household appliance 26 so that the introduction device 22 can later communicate with the household appliance 26 in a secure manner using known cryptographic techniques without the need for using the proximity based secure channel. Further, per-device keys allow rekeying of remaining devices to take place when a device possessing a group key is removed from a federation.

Next, in step S104, the introduction device 22 generates security information for the federation, such as a group key, per-device cryptographic keys, and access control information. Alternatively, the appliance 26 could generate the security information for the federation or the security information could be generated by a separate device such as a personal or notebook computer and then stored in either the introduction device 22 of the appliance 26. In step S106, the introduction device 22 transfers the security information to the appliance 16 via the secure communications channel. It will be understood by those of skill in the art that the steps may be performed in an order other than that shown in FIG. 2A. For example, although step S104 is shown as occurring after steps S100, S102, step S104 could occur anywhere before step S106. Similarly, step S102 could occur after step S106. In the presently preferred embodiment, step S104 occurs before step S100.

The introduction device is then connected to a second appliance 28 (step S108 and FIG. 2C), in this example a broadband gateway, in the same manner as it was connected to the household appliance 26. Although the second appliance 28 in FIG. 2C is a broadband gateway, it could be another device. That is, a federation does not have to include a broadband gateway.

Again, in the presently preferred embodiment, the introduction device 22 is placed in close proximity to the second appliance 28 and more preferably, is placed in direct contact with the second appliance 28 in order to establishing a secure communications channel between the introduction device 22 and the second appliance 28 (step S110). Once a secure communications channel is established, in step S112 the security information, such as the federation group key is transferred from the introduction device 22 to the second appliance 28. Thereafter, the first and second appliances 16, 28 are members of the same federation and can communicate with each other in a secure manner using a public, shared or unsecure network. Adding further appliances to the federation only requires that the security information be transferred between the introduction device 22 and the new appliance. Existing members of the federation are not involved. Once the new appliance has the security information for the federation, the new appliance can communicate with any device or appliance in the federation. It is important to note that the invention concerns the use of establishing a secure communications channel, such as via proximity or direct contact, and is not limited to the use of any particular cryptographic protocol.

The introduction device 22 can also introduce an appliance into a number of federations at the same time by transferring an appropriate group key or by transferring multiple group keys from the introduction device 22 to the appliance.

In order to delete or remove an appliance or device from a federation of appliances, the introduction device 22 overwrites or erases the federation group key stored in that appliance. Another way of removing an appliance from a federation is, for example, to introduce the appliance into a new federation by overwriting it's group key with a new group key, thereby breaking communication with the previous federation.

Alternatively, a new group key can be provided to the federation appliances except for the appliance to be removed. Removing a device from a federation by changing the security information on all of the devices except for the device to be removed from the federation need not be done with a secure channel, since the introduction device 16 can use the device keys collected in step S102 to protect the new group key during transmission to each device in the federation. The device to be removed is not sent a copy of the new key, thus preventing it from eavesdropping on traffic sent between members of the federation in the future.

The introduction device 22 can also be used to copy part or all of the security information collected in step S102 to another device, such as a computer system with secure backup storage, or another introduction device so that a failure of the introduction device 22 is not catastrophic and does not require all devices to be re-introduced to each other.

In the same manner that a federation is created, a new appliance may be added to an existing federation of appliances by placing the introduction device 22 in close proximity to the new appliance to establish a secure communications channel between the new appliance and the introduction device 22 (e.g., step S108) and transferring security information of the federation from the introduction device 22 to the new appliance. The introduction device 22 preferably also collects a device key from the new appliance after it establishes a secure communications channel with the new appliance.

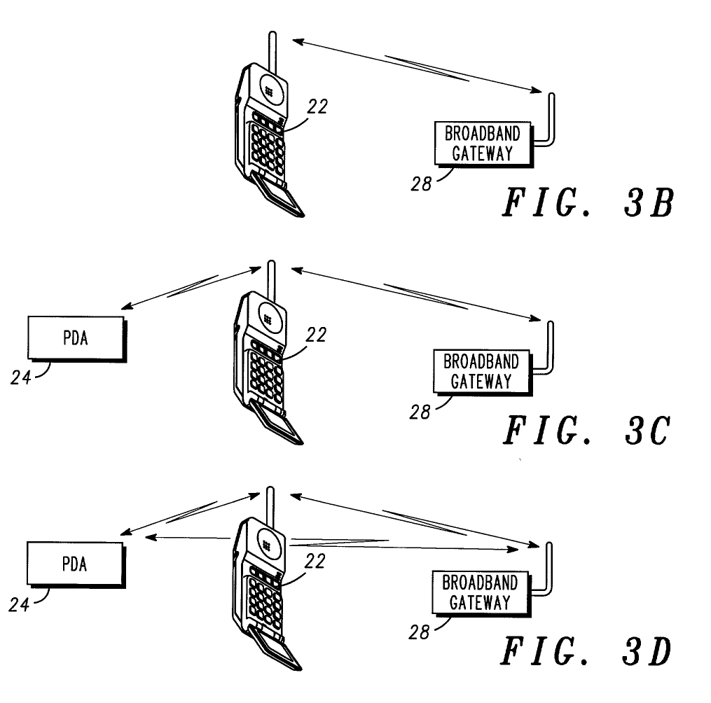

Referring now to FIGS. 3A-3D, an example of the addition of an appliance to an existing federation of appliances will be discussed. FIG. 3A is a flowchart illustrating the addition of an appliance, in this case a PDA 24 to an existing federation of appliances. FIGS. 3B-3D show the addition of the PDA 24 to the federation in accordance with the flowchart of FIG. 3A.

In this example, as shown in FIG. 3B a mobile phone 22 and a gateway 28 are already configured to communicate with each other and the federation information is stored in the mobile phone 22. The PDA 24 is not yet configured to communicate with either the mobile phone 22 or the gateway 28. As shown in FIG. 3C, in step S120 the mobile phone 22, acting as an introduction device, is placed in close proximity to the PDA 24. As previously discussed with reference to FIG. 2A, in step S122 a secure communications channel is established between the PDA 24 and the mobile phone 22 and security information is transferred between these devices. That is, the PDA device key is transferred from the PDA 24 to the mobile phone 22 and a group key is transferred from the mobile phone 22 to the PDA 24. The PDA 24 is now configured to communicate with the gateway 28 and the mobile phone 22 (FIG. 3D).

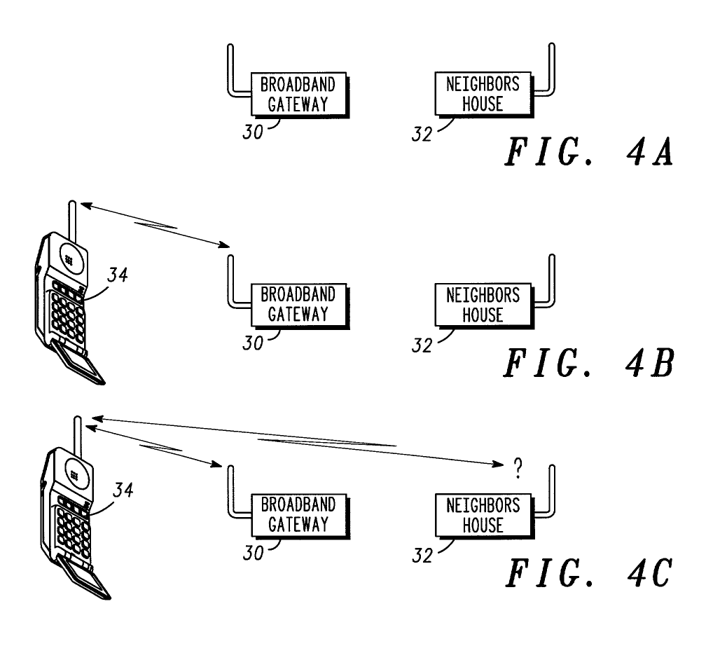

FIGS. 4A-4C are a series of drawings showing the addition of a mobile telephone 34 to a federation in accordance with the present invention. Referring to FIG. 4A, a first gateway 30 is installed in the home or office of a first party. The first gateway 30 stores the first party's security information and also connects the first party's appliances with a network. The appliances communicate with the gateway 30 using a wireless communication scheme as will be understood by those of skill in the art. A second gateway 32 resides in a neighboring home or office and is used by a second party to communicate with his own appliances (not shown). As will be understood, communications between the first party's appliances and the first gateway 30 could be intercepted by the second gateway 32, and similarly, communications between the second gateway 32 and its appliances could be intercepted by the first gateway 30.

Referring now to FIG. 4B, in this example, the first party has a new mobile phone 34 to be introduced to the first gateway 30. First, the first party places the new phone 34 in close proximity to the first gateway 30 so that a secure communication channel can be established between the new phone 34 and the first gateway 30. Then, the first gateway 30 receives a device key from the new phone 34 and transmits federation security information to the new phone 34. In this manner the new phone 34 is configured for use outside of the first party's home and also with the first gateway 30 via a local wireless LAN connection. However as shown in FIG. 4C, since the new phone 34 does not have the security information stored in the second gateway 32, the phone 34 cannot communicate with the second gateway 32 and thus, cannot access the wireless devices of the second party.

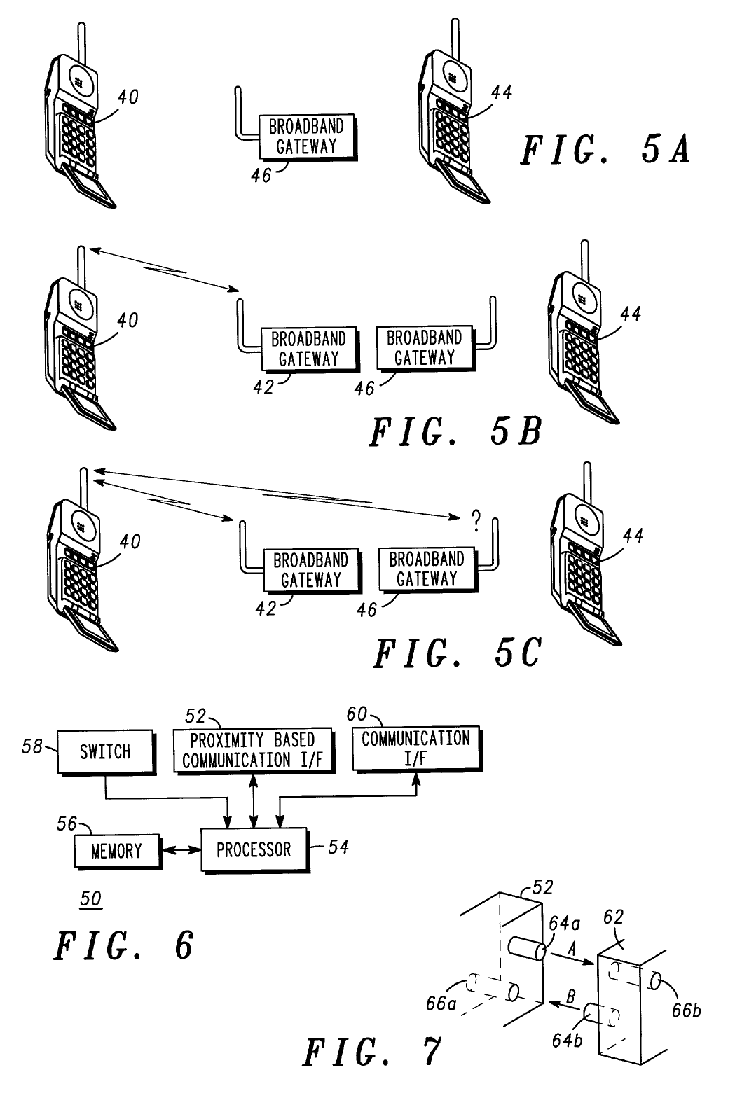

FIGS. 5A-5C are a series of drawings showing the introduction of a gateway as a new device to a federation in accordance with the present invention. Referring to FIG. 5A, a first federation of a first party includes a first mobile phone 40 and a second federation of a second, neighboring party includes a second mobile phone 44 and a second gateway 46. The second gateway 46 provides a wireless connection for appliances of the second party, allowing the second party appliances to communicate with each other and with remote devices via the gateway 46. For example, the second mobile phone 44 communicates with the second gateway 46 via a wireless connection. The second party could have other appliances configured for wireless communication with each other and the second mobile phone 44 via the second gateway 46.

Referring now to FIG. 5B, the first party has a gateway 42 to be configured for communication with the mobile phone 40. The unconfigured gateway 42 is introduced to the first phone 40 by placing the first phone 40 in close proximity to the gateway 42 so that a secure communications channel can be established and security information passed between the devices. In this example, although the first phone 40 is shown acting as an introduction device, it is to be understood that a separate introduction device could be used to configure the new gateway 42 for communication with the first phone 40.

Once the first gateway 42 has passed its device key to the first phone 40 and the first phone 40 has transmitted federation security information to the first gateway 42, as shown in FIG. 5C the first phone 40 and the first gateway 42 can communicate with each other but not with the second gateway 46. Similarly, the second phone 44 can communicate with the second gateway 46 but not with the first gateway 42, even though the wireless signals may be received by the first gateway 42. Since the present invention uses proximity based secret exchange, the neighbor's appliances and gateway 46 are not allowed to communicate with the first phone 40 or first gateway 42.

The introduction aspect while shown via examples with mobile phones is applicable to any portable wireless device with a separate out of band proximity based connection capability.

Referring now to FIG. 6, a schematic block diagram of an introduction device 50 according to one embodiment of the present invention is shown. The introduction device 50 is designed for assigning an appliance to a federation of appliances in a secure manner. Rather than relying on the transmission of encrypted data, it is preferred to use a proximity based secure transmission system. However, although the use of proximity and secret propagation using proximity are the basis for the invention, it will be understood by those of ordinary skill in the art that cryptographic protocols may be used in addition to the proximity solution.

The introduction device 50 thus includes a proximity based communications port 52 that permits secure transfer of information between an appliance and the introduction device 50 when the communications port 52 is placed in close proximity to a complementary proximity based communications port of the appliance. The communications port 52 may be an infrared port, a very short-range wireless port or a contact based port. The communications port 52 may comprise a single bi-directional signal wire connected to an electrical connector or two or more signal wires respectively connected to a transmit connector and a receive connector.

A processor 54 is connected to the proximity based communications port 52. The processor 54 is essentially the brain of the smart appliance and manages and monitors the many tasks performed by the appliance. The processor 54 may comprise any type of known processor, from a simple 8-bit processor to a more sophisticated digital signal processor. Such processors are well known to those of ordinary skill in the art and are readily available from a variety of manufacturers, such as Motorola Corp. of Schaumburg, Ill., the assignee of the present invention.

A memory 56 is connected to the processor 54 for storing security information, such as per-device keys, federation or group keys, and other access control information. The memory 56 may be a nonvolatile memory and preferably is RAM. The memory 56 may be separate from or integral with the processor 54.

Preferably a switch 58 is connected to the processor 54 for signaling the processor 54 to communicate with an appliance that has been placed in close proximity to the communications port 52. Activation of the switch 58 signals the processor 54 to transfer the security information between the appliance and the device 50 via the proximity based communications port 52. In other words, the switch 58 causes the processor 54 to perform the aforementioned method of introducing a new appliance to a federation or removing an appliance from a federation. The switch 58 may be a contact type switch connected directly to the processor 54 or connected to the processor 54 via the proximity based communications port 52. Further, the switch 58 may be a sensor that is integral with the port 52 such that when a complementary port is placed in contact with the port 52, the switch is automatically activated. The switch 58 could also be implemented in software. An alternative to the switch 58 would be to have the device 50 either continuously or periodically attempt to perform the aforementioned introduction method.

If the introduction device 50 is not a stand-alone introduction device, such as a wand, but is built into an electronic device or appliance that has a primary function other than performing introduction, e.g., a cell phone or a PDA, then, according to the present invention, it is preferred that the proximity based communications port 52 be separate from an appliance communications interface 60 that is connected to the processor 54 and used to communicate with other appliances, by transmitting to and receiving data from other appliances in the federation of appliances. The communications interface 60 may be either a wired or a wireless interface and may conform to a proprietary protocol or a standard protocol. Further, the communications interface 60 may be either serial or parallel and synchronous or asynchronous interface so long as it allows the appliance to communicate with other appliances or an authorized remote device. In the presently preferred embodiment, the introduction device 50 is a portable device, such as a mobile telephone, a personal digital assistant and a wand.

Referring now to FIG. 7, one embodiment of a portion of the proximity based communications port 52 is shown along with a second proximity based communications port 62 of another appliance or device. As can be seen, the proximity based communications ports 52, 62 are mirror images. Each of the ports 52, 62 includes a transmit side connector 64a, 64b and a receive side connector 66a, 66b. The transmit side connector 64a transmits data to the receive side connector 66b and the transmit side connector 64b transmits data to the receive side connector 66a. The transmit side connectors 64a, 64b are designed to be received by the receive side connectors 66b, 66a, respectively. That is, the connectors 64a, 64b are generally cone shaped and project out from the port 52, 62 while the connectors 66a, 66b are openings sized to receive the connectors 64a, 64b. When the connector 64a is inserted into the connector 66b, if the connector is a light based connector, then light does not escape or leak out of the receiving connector 66b. The connectors 66a, 64b mate in a similar manner. Thus, it can be seen that such mating connectors provide a secure interface and security information transmitted between the device 52 and the appliance 62 is secure. The communications ports may be required to physically contact or touch each other or just be very close to each other, depending on the communications technology (wired, light based, RF, etc.) used, so long as a secure transmission is provided. The touching may be detected by having a button on each device that must be depressed and released at the same time.

From the foregoing, it can be seen that the introduction device of the present invention introduces third-party devices to each other. The device is analogous to a person who introduces two strangers to each other. The introduction device is used to establish a secure channel with each device in turn, and transfer security information that allows the devices to communicate securely with each other over an untrusted network. As previously discussed, the security information that the introduction device transfers to third party devices includes per-device cryptographic keys, access control information, and group keys.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A method of creating a federation of appliances, comprising the steps of:
placing an introduction device in close proximity to a first appliance;
establishing a secure communications channel between the introduction device and the first appliance;
transferring security information of the federation between the introduction device and the first appliance;
placing the introduction device in close proximity to a second appliance;
establishing a secure communications channel between the introduction device and the second appliance; and
transferring the security information from the introduction device to the second appliance, wherein the first and second appliance are thereafter members of the federation.

2. The method of claim 1, further comprising the step of:
after placing the introduction device in close proximity to the first appliance, the introduction device collecting a first device key from the first appliance.

3. The method of claim 2, wherein the introduction device uses the first device key to communicate with the first appliance.

4. The method of claim 1, wherein the security information comprises a group key.

5. The method of claim 4, further comprising the steps of:
providing a new group key to the first appliance, the new group key overwriting the previously stored group key, thereby removing the first appliance from the federation.

6. The method of claim 1, wherein the placing of the introduction device in close proximity to the first and second appliances comprises placing the introduction device in direct contact with the first and second appliances.

7. The method of claim 1, wherein the establishing of a secure communications channel between the introduction device and the first and second appliances comprises using cryptographic techniques.

8. The method of claim 7, wherein the security information comprises cryptographic keys and access control information.

9. A method of adding an appliance to a federation of appliances, comprising the steps of:
placing an introduction device in close proximity to the appliance;
establishing a secure communications channel between the appliance and the introduction device; and
transferring security information of the federation from the introduction device to the appliance, wherein the appliance is thereafter a member of the federation.

10. The method of claim 9, further comprising the step of:
after establishing the secure communications channel, the introduction device collecting a device key from the appliance.

11. The method of claim 10, wherein the introduction device uses the device key to communicate with the appliance.

12. The method of claim 9, wherein the placing of the introduction device in close proximity to the appliance comprises placing the introduction device in direct contact with the appliance.

13. The method of claim 9, wherein the establishing of a secure communications channel between the introduction device and the appliance comprises using cryptographic techniques.

14. The method of claim 9, wherein the security information comprises a group key.

15. The method of claim 9, wherein the security information comprises cryptographic keys and access control information.

16. An introduction device for assigning an appliance to a federation of appliances in a secure manner, comprising:
a proximity based communications port that permits secure transfer of information between an appliance and the introduction device when the communications port is placed in close proximity to an appliance communications port;
a processor connected to the proximity based communications port; and
a memory connected to the processor for storing security information the processor communicates with the appliance such that the processor reads the security information from the memory and transmits the security information to the appliance via the proximity based communications port.

17. The introduction device of claim 16, further comprising a switch connected to the processor for signaling the processor to communicate with the appliance.

18. The introduction device of claim 17, wherein the switch is integral with the proximity based communications port.

19. The introduction device of claim 16, further comprising a communications interface connected to the processor for transmitting to and receiving data from other appliances in the federation of appliances.

20. The introduction device of claim 16, wherein the introduction device comprises one of a mobile telephone, a personal digital assistant and a wand.

21. The introduction device of claim 16, wherein the security information transmitted to the appliance comprises access control information, cryptographic keys, or a group key.

22. The introduction device of claim 16, wherein the proximity based communications port comprises a mirror image of the appliance communications port such that the proximity based communications port mates with appliance communications port when placed in contact therewith.

23. A smart appliance that is capable of communicating with other smart appliances, comprising:
a proximity based communications port that permits secure transfer of information between the smart appliance and an introduction device when the communications port is placed in close proximity to a proximity based communications port of the introduction device;
a processor connected to the proximity based communications port; and
a memory connected to the processor for storing security information, wherein the processor communicates with the introduction device such that the processor reads the security information from the memory and transmits the security information to the introduction device via the proximity based communications port.

24. The smart appliance of claim 23, further comprising a communications interface connected to the processor for allowing the smart appliance to communicate with other smart appliances.

25. The smart appliance of claim 23 further comprising a switch connected to the processor for signaling the processor to communicate with the introduction device.

26. The smart appliance of claim 25 wherein the switch is implemented in software.
